(19) United States
(12) Patent Application Publication
(10) Pub. No.: US 2006/0282358 A1
(43) Pub. Date: Dec. 14, 2006

(54) Method for facilitating real estate investments and investment management thereof

(75) Inventors: Donald K. Cavin, Dacula, GA (US); Tonia R. Mann-Cavin, Dacula, GA (US)

Correspondence Address: RUBEN C. DELEON;WINSTEAD SECHROST & MINICK P.C., P.O. BOX 50784, DALLAS, TX, 75201, US

(73) Assignee: Tonia Mann, Ltd., Dacula, GA (US)

(21) Appl. No.: 11/148,900

(22) Filed: Jun. 9, 2005

(51) Int. Cl. G06Q 40/00

(52) U.S. Cl. 705/35

(57) ABSTRACT

A method for facilitating real estate investments for formulating, managing and facilitating an investment strategy for a variety of property types and geographic markets. The method provides a real estate investment model having a cash flow while providing a back end equity build. Further, the method permits control of equity growth of several hundreds of thousands of dollars in single family residential real estate with only a few tens of thousands of cash out-of-pocket, and very little sweat equity. The method provides a tool for real estate investment that can be implemented and managed largely from an investor's/user's desk. The investment method provided gives the investor the benefit of new home warranties, so that repairs are largely taken care of by someone else. The method offers an impressive upside potential secured by real estate, paid for with a tenant/purchaser's money.

### CROSS-REFERENCE TO RELATED APPLICATION

This application is not related to any pending application.

### FIELD OF THE INVENTION

The present invention relates generally to a method for real estate investment. In particular, the invention relates to assisting real estate investors via a method which systemizes a real estate investment model in relation to the acquisition of quality property, advantageous financing, the elimination of holding costs, the reduction of marketing time and costs, the elimination of specific maintenance costs, and the minimization of investment cash to allow acquisition of a variety of property types in various geographic markets.

### BACKGROUND OF THE INVENTION

Real estate investments have provided a plethora of investors with positive cash flow, tax benefits and satisfaction of making an impact in others lives. Like any investment however, real estate has intricate nuances and market trends that when ignored can cause an investor tremendous heartache.

Unbelievably, many first time investors are willing to part with their hard earned cash without taking the time to study their investment. They rely on traditional trends and gut feelings. Before one risks their investment, they should take the time to learn all about the relative market. There tend to be several common mistakes and problems that consumer's investing in real estate makes and/or encounter that typically prevents an excellent return on their investment.

First, is the failure to determine the specific time need. Specifically, cash flow, capital appreciation, tax benefits, loss of management, equity pay down and pride of ownership are just some of the things that need to be addressed before certain real estate investments should be made.

Second, is not checking out the seller or seller's agent's numbers. Claims of extremely high rates of return run rampant in real estate investment. It is easy for a new investor to get caught up in the excitement. It is important for all investors, in particular new investors in real estate, to check everything including, but not limited to, the rent, payment history, taxes, expenses, deposits, future modifications regarding the investment property. The key is to check and know everything. However, this is typically very difficult to do, especially when an investor is new to and not familiar with a specific marketplace. It is important that one covers and knows how to handle the seemingly insignificant but very important details.

Another mistake that real estate investors typically forget is that you are buying into a business. Owning investment property carries with it a great potential for creating wealth and some potentially difficult decisions. Evictions, re-investment into the property and time management all need careful consideration.

Lastly, one must try to avoid negative cash flow. Property that demands cash every month can drain the investor's working capital. This can create stress, frustration and become quite painful. A strain on your cash flow may cause one to sell the investment before the benefits of ownership are ever realized.

As a result of the above encountered problems by real estate investors, new and experienced alike, there is a need for an approach to providing an investment with a good cash flow while providing a back end equity build. Within any investment process, it is not uncommon for minds to differ on what factors contribute to the formulation of a successful investment strategy. For example, it is recognized that many believe that investment performance is attributed primarily to the broader market, i.e., the quality of investment decision primarily reflects the quality of the underlying market. Others may hold a different view. Such controversy during the investment strategy formulation process can be polarizing and differing opinions about the underlying investment market can lengthen the timing of the process and add complexity.

Thus, there is a need to reach consensus of an investment deal transaction. Such consensus needs to be reached by having in place, a framework that is agreed upon, in advance, by all parties proceeding through the investment process. The framework would be used to provide an investment with a good cash flow while providing a back end equity build. The framework should allow one to control the equity growth of several hundreds of thousands of dollars of single family residential real estate with the least possible cash out-of-pocket and very little sweat equity.

In today's market home ownership continues to be the “American Dream.” However, a significant number of people have damaged credit and cannot qualify for a mortgage. Typically, real estate investors must acquire the property and then manage and pay for the rehabilitation of the property. It is not uncommon in today's market for loan products for rehabs to cost more and be harder to obtain. Additionally, the investor becomes an owner of a non-revenue generating asset because there is usually no revenue generated during the rehab process. Usually, the rehab process frequently costs more than the original project estimate and takes longer to complete than originally budgeted, resulting in monthly holding costs exceeding the budget. When finished, you still own an old house, in an older neighborhood, which is often more difficult to rent.

### SUMMARY OF INVENTION

To the accomplishment of the foregoing and related ends, the invention comprises the features hereinafter fully described and particularly pointed out in the claims. The following description and the annexed drawings set forth in detail certain illustrative embodiments of the invention. These embodiments are indicative of but a few of the various ways in which the principles of the invention may be employed. Other objects, advantages and novel features of the invention will become apparent from the following detailed description of the invention when considered in conjunction with the drawings.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The present invention provides an investor with a method that assists the investor in the acquisition of quality property that will appreciate rapidly by taking advantage of the “Builder's Pricing Model.” Further it assists the investor by reducing the investment of time required to build and maintain a real estate portfolio in addition to maximizing the difference between monthly costs and the rental income. The method helps to minimize the cash invested to allow acquisition of more investment property and to take advantage of lower capital gain rates or to defer taxable gains through tax-deferred exchanges.

It is an object of the investment method of the present invention to enable an investor to acquire quality property that will appreciate rapidly be taking advantage of the “Builders Pricing Model” disclosed herein.

It is another object of the present investor to take advantage of long term financing available for investors to reduce the time required to build and maintain a real estate portfolio.

It is a further object of the present invention to eliminate holding costs that are common while preparing a fixer-upper lease property.

It is another object, of the method of the present invention to reduce the marketing time and costs to obtain a tenant.

It is yet a further object to reduce or eliminate maintenance costs in real estate ownership by utilizing the protection afforded by the builder's warranty and the New Home Warranty.

It is another object of the method of the present invention to maximize the difference between an investor's monthly costs and the rental income.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

These and other objects, features and advantages of the present invention will be more readily apparent when considered in connection with the following, detailed description of preferred embodiments of the invention, which description is presented in conjunction with annexed drawings below.

### BRIEF DESCRIPTION OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 depicts a diagram of the common elements of a traditional home search conducted by a realtor for a home buyer; and

FIGS. 2A and 2B depict a flow chart diagram of an embodiment for a method for facilitating real estate investments according to the method of the present invention.

### DETAILED DESCRIPTION

To the accomplishment of the foregoing and related ends, the invention comprises the features hereinafter fully described and particularly pointed out in the claims. The following description and the annexed drawings set forth in detail certain illustrative embodiments of the invention. These embodiments are indicative of but a few of the various ways in which the principles of the invention may be employed. Other objects, advantages and novel features of the invention will become apparent from the following detailed description of the invention when considered in conjunction with the drawings.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

Generally, the present invention is described as a method and model for providing, managing and facilitating real estate investments and real estate investment management models. This method utilizes a real estate investment model having a cash flow while providing a back end equity build. Further, the method of the present invention permits control of equity growth of several hundreds of thousands of dollars in single family residential real estate with only a few tens of thousands of cash out-of-pocket, and very little sweat equity. The present invention provides a tool for real estate investment that can be implemented and managed largely from a user's desk. The investment method provided gives the investor the benefit of new home warranties, so that repairs are largely taken care of by someone else. Therefore, by the time that the real estate property investments are in need of repair, the real estate investment will be the property of the tenant/purchaser, thereby reducing the usual maintenance expenses for the property and therefore increasing the net equity in any given investment property. In addition, once the property is owned by the tenant/purchaser the investor will have secured profits equivalent to those needed to invest in two to three new investment properties. This method offers an impressive upside potential secured by real estate, paid for with a tenant/purchaser's money.

The investment method utilizes data residing in a database of well built new homes that are located in various quality subdivisions. Decision factors are input consisting of properties located in a highly desirable location relative to one's work, schools, and shopping. Typically, the method utilized by the present invention emphasizes homes that are built in Phase I or II of relatively large multi-phase developments and pertains to specific homes that are among the less expensive in the development.

Furthermore, the method of the present invention draws from a frequently updated database of properties, each of which are published on a password protected website, that consist of large developments that are in several stages of the build phase. The investment method is adapted to utilize property amenities to make the neighborhood attractive as it is built out and developed. Such adaptive modeling increases the prices (“profits for the investor”) for the same model home as the development moves through each phase. For example, specific developments would sell the same house for $10,000 to $20,000 or more in later phases of that particular development. As a result this will increase the appraised value of the properties managed by the software model in the first phases by this amount. According to an embodiment of the method of the present invention an investor utilizes an investment model that provides investment controls of a real estate asset valued at $150,000 or more, with an investment of 10 percent or less. By using an embodiment of the method of the present invention, combined with real estate leverage, the real estate investment literally “buys itself”. In other words, a tenant's rent payments will effectively “buy” the property for the investor. According to the present model disclosed herein, the tenant purchases a non-refundable $4,000 to $8,000 “Option to Purchase” contract, partially offsetting the initial investment. The tenant's rent, as determined by the method, then averages $200 to $500 per month more than the mortgage payments. The lease term is set for at least 2 or more years to enable the investment to become a long term capital investment, thus avoiding harsher taxes. At the end of the lease period, the tenant agrees to purchase the property at an appreciated value.

The use of the present invention's method and model for real estate investing is unique from the normal “Realtor-Buyer Model”. The following is a comparison of the traditional homebuyer services to the investor homebuyer service provided by the present invention's method and model of investing.

In a typical single family home buyer concept, the realtor works with an owner occupant to obtain a home that meets their needs. Typically, the home buyer's focus is on a single transaction to purchase a single home for their personal residence.

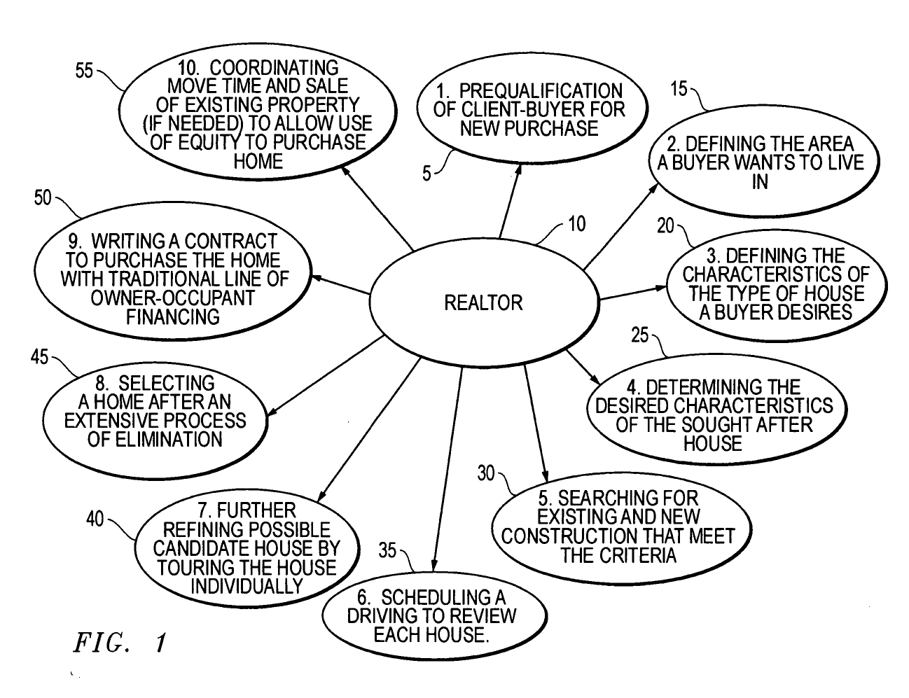

With specific reference now to FIG. 1, the step elements of a typical traditional home search the “Realtor-Buyer Model” are:

According to the first step 5, a realtor 10 takes steps to prequalify a client for purchasing a home. This may include many standard processes and procedures implemented by various realtors.

Step 15, shows that the realtor 10 interacts with the buyer to define the area where the buyer wants to live. In the next Step 20, the realtor 10 defines the characteristics of the type of home the buyer desires. Next, in Step 25, the realtor 10 next determines the desired characteristics of the house that a particular buyer wants to purchase to live in. Following Step 25, the next Step 30 involves the realtor 10 searching for existing and new construction that meet the above criteria.

Following Step 30, the realtor 10 schedules a drive with the buyer to review each house 35 that met the buyer's criteria of Step 25. In addition, many times a realtor 10 must further refine possible candidate homes by touring the homes individually as is depicted in Step 40 of FIG. 1. As a result, Step 45 depicts that a selection of a home is finally made after an extensive selection process with the buyer and realtor 10.

Step 50 then indicates that a contract is written for purchase of the home selection made in step 45. This purchase is typically made with a traditional line of owner-occupant financing. Finally, as a conclusive result of the previous Steps discussed above, the realtor 10 coordinates, per Step 55, a move time and sale of the buyer's existing property (if needed) to allow use of equity to purchase home.

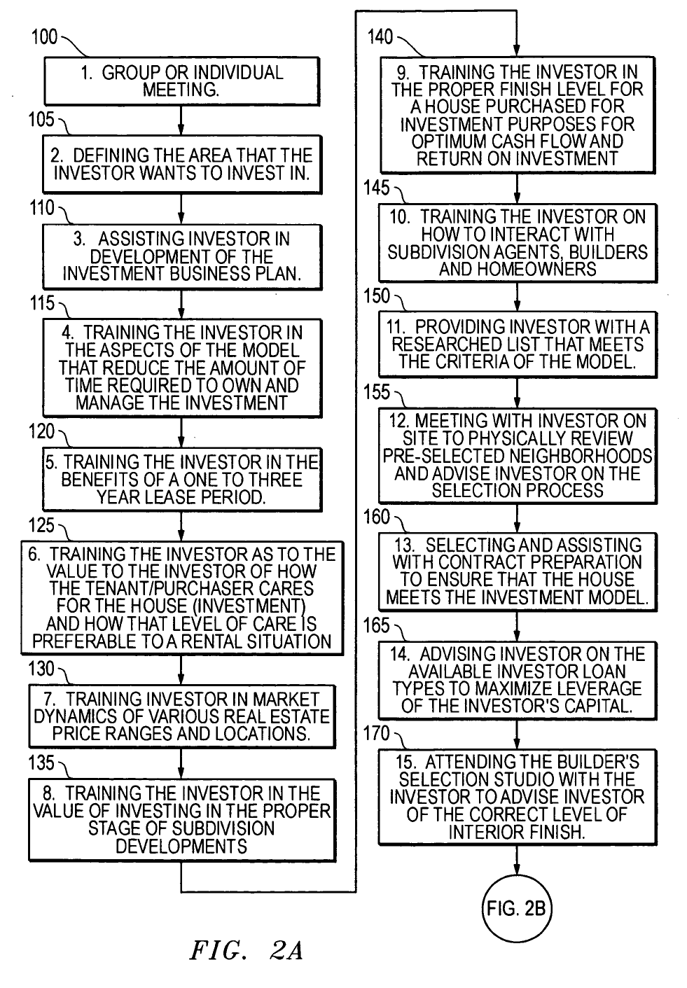

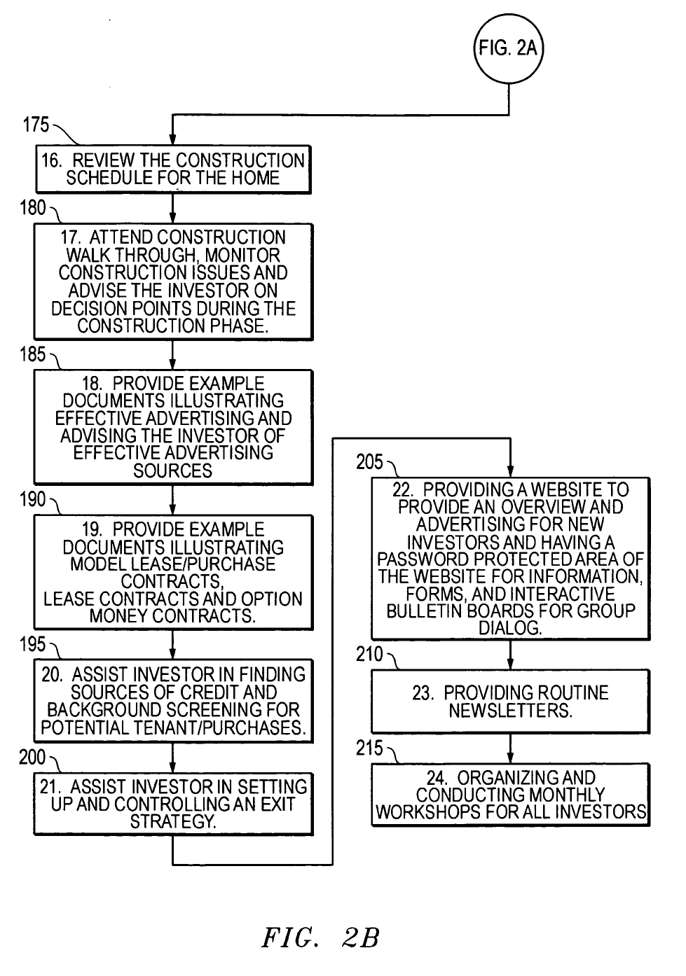

In reference now to FIGS. 2A and 2B, in comparison to the elements listed above in relation to FIG. 1, the elements of an investor deal according to the present invention's investment method and model provide a need yet to be resolved and include a much more intricate strategy. FIG. 2 sets forth a flow chart diagram of an embodiment for facilitating real estate investments and management models thereof of the present invention. FIGS. 2A and 2B include an investor who is desirous of setting up a real estate investment plan according to the methodology of the present invention.

As shown in FIGS. 2A and 2B, as initially referenced in FIG. 2A, the method of facilitating a real estate investment comprises:

Step 100: Group or Individual meeting with investor to determine investment goals and timeframe;

Step 105: Defining the area that the investor wants to invest in;

Step 110: Assisting Investor in development of the Investment business plan in homes that fit the model;

Step 115: Training the investor in the aspects of the model that reduce the amount of time required to own and manage the investment;

Step 120: Train the investor in the benefits of a one to three year lease period so that the tenant/buyer purchases the home while it is new and warranted by the builder and explaining how this is time effective for the investor;

Step 125: Train the investor as to the value to the investor of how the tenant/purchaser cares for the house (investment) and how that level of care is preferable to a rental situation that might typically result in much higher maintenance costs from tenants who just have the mentality of a renter towards the house;

Step 130: Training investor in market dynamics of various price ranges and locations;

Step 135: Training the investor in the value of investing in the proper stage of subdivision developments for optimum return;

Step 140: Training the investor in the proper finish level for a house purchased for investment purposes for optimum cash flow and return on investment;

Step 145: Training the investor on how to interact with subdivision agents, builders and homeowners that they may encounter so that our investors fit quietly into a neighborhood. This reduces the impact of a neighborhood appearing to have several “rental homes”, thus reducing any negative impact of our investors on the growth and appreciation of the neighborhood;

Step 150: Providing investor with a researched list of subdivisions that meet the criteria of the model;

Step 155: Meeting with investor on site to physically review selected neighborhoods and advise investor on the selection process and focus on the aspects of each subdivision that impact investment value;

Step 160: Selecting and assisting with contract preparation to insure that the house meets the investment model and advising the investor where the house does not meet the investment model;

Step 165: Advising investor on the available investor loan types to maximize leverage of the investor's capital while meeting the short term cash-flow needs;

Step 170: Attending the builder's selection studio with the investor to advise investor of the correct level of interior finish to provide a solid investment yet keep the emotions of the selection studio process from having the investor make selections as if the home were to be the investor's personal residence;

As now referenced on FIG. 2B (which is continued from FIG. 2A) the method steps continue as follows:

Step 175: Review the construction schedule for the home versus the necessary marketing approach to obtain a tenant/buyer for the home;

Step 180: Attend construction walk through, monitor construction issues and advise the investor on decision points during the construction phase;

Step 185: Provide example documents illustrating effective advertising and advising the investor of effective advertising sources;

Step 190: Provide example documents illustrating model lease/purchase contracts, lease contracts and option money contracts; (FIG. 4 provides a non-limiting example of such contracts available for the investor to utilize. All dates utilized herein and on such samples are for example only and are not meant to be limiting in any sense.)

Step 195: Assist investor in finding sources of credit and background screening for potential tenant/purchasers;

Step 200: Assist investor in setting up and controlling an exit strategy so that the tenant/purchaser is most likely to be ready to purchase the home at the end of the lease term;

Step 205: Providing a website to provide an overview and advertising for new investors and having a password protected area of the website for Information, Forms, and Interactive Bulletin Boards for group dialog, etc.;

Step 210: Providing routine newsletters to the group to advise of pertinent group and market developments; and

Step 215: Organizing and conducting monthly workshops for all investors so that a group synergy and a sharing of ideas reduces competition and builds a team approach to investing.

Not by way of limitation, an example of the method and functionality of the present invention is provided by implementation of the investment model method as utilized with an investment property is as follows. (The dates used herein are for illustrative purposes only.)
1. Acquire home for $160,000 with 5% down (Oct. 200X);
2. Value at closing $175,000 (Jan. 200X);
3. Finance at $750.00/mo. (Jan. 200X);
4. Lease with $5,000 Purchase option and $1250/mo for 3 years prior to closing;
5. At the end of 3 years (Jan. 200X);
6. Rental Income at 500.00×36 month=$18,000.00;
7. Equity build at close=$15,000.00;
8. Equity build over 3 years=$36,750.00;
9. Less Taxes, Insurance and Down Payment=−$15,200.00; and
10. Net Gain on˜$10,000/36 month investment=$54,550.00.
   **Values approximate those on recent trends in actual new construction.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired.

It is therefore, contemplated that the claims will cover any such modifications or embodiments that fall within the true scope of the invention.

What is claimed is:

1. A method for facilitating real estate investments for an investor, the method comprising:
providing a real estate investment management model for an investor;
assisting the investor in development of an investment plan that conforms to the investment management model;
providing the investor with investment opportunities that meet criteria of the investment model;
advising the investor in maximization of capital; and
providing an accessible database for investors.

2. The method as in claim 1 further comprising, after the step of providing a real estate management model, the step of conducting an initial meeting with the investor.

3. The method as in claim 2 wherein the initial meeting comprises meeting to discuss and determine the investor's investment goals and investment timeline.

4. The method as in claim 1 wherein the step of assisting the investor in development further comprises assisting the investor in choosing certain types of homes.

5. The method as in claim 1 further comprising, after the step of assisting the investor in development, the step of training the investor.

6. The method as in claim 5 wherein training the investor comprises training in aspects of an investment model that reduces an investor's time required to own and manage the real estate investment.

7. The method as in claim 5 wherein the step of training the investor further comprises training the investor in various benefits including one, two, three year lease periods and home warranties.

8. The method as in claim 5 wherein the step of training the investor further comprises training the investor on the dynamics involved in the real estate market as relating to various real estate price ranges and locations.

9. The method as in claim 5 wherein the step of training the investor further comprises training the investor in the value of investing in subdivisions in various stages of completion for allowing optimum investment return.

10. The method as in claim 5 wherein the step of training the investor further comprises training the investor in the proper finish level for a house as relating to optimization of cash flow and return on the investment.

11. The method as in claim 5 wherein the step of training the investor further comprises training the investor how to interact with subdivision agents, builders and homeowners.

12. The method as in claim 1 further comprising, after the step of providing the investor with investment opportunities, the step of meeting onsite with the investor at predetermined investment opportunity locations includes reviewing selected neighborhoods.

13. The method as in claim 12 wherein the step of meeting onsite further comprises advising the investor on the investment opportunity in selected neighborhoods and how that opportunity impacts the investment value.

14. The method as in claim 13 wherein after the step of advising the investor on the investment opportunity the method further comprises the steps of selecting, assisting and advising with purchase contract preparation to ensure that the house selected meets the investment model.

15. The method as in claim 14 further comprising the step of advising the investor as to how selected houses do not meet the investment model.

16. The method as in claim 1 further comprising, after the step of advising the investor in maximization of capital, the step of attending a builder's selection studio with the investor.

17. The method as in claim 16 wherein the step of attending further comprises advising the investor of the correct levels of interior finish to provide a solid investment.

18. The method as in claim 17 further comprising, after the step of advising the investor of the correct levels, the step of reviewing the construction schedule for the home.

19. The method as in claim 18, after the step of reviewing, the step of attending a construction walk-through comprising monitoring construction issues and advising the investor on decision points during the construction phase.

20. The method as in claim 19, after the step of attending a construction walk-through, the step of providing sample advertising documents that illustrate effective advertising and advising the investor of effective advertising sources.

21. The method as in claim 20, after the step of providing sample documents, the step of providing sample contract documents that illustrate model lease/purchase contracts, lease contracts and option money contracts.

22. The method as in claim 1 further comprising, after the step of advising the investor in maximization of capital, the step of assisting the investor in finding sources of credit and background screening for potential tenant/purchasers.

23. The method as in claim 1 further comprising, after the step of advising the investor in maximization of capital, the step of assisting the investor in setting up and controlling an exit strategy.

24. The method as in claim 1 further comprising, after the step of advising the investor in maximization of capital, of organizing and conducting workshops for the investor.

25. The method as in claim 1 further comprising providing newsletters advising of market developments.
